(19) United States
(12) Patent Application Publication
(10) Pub. No.: US 2008/0020248 A1
(43) Pub. Date: Jan. 24, 2008

(54) Hydrocarbon gas carbon nanotube storage media

(75) Inventors: K. R. Sridhar, Los Gatos, CA (US); James McElroy, Suffield, CT (US); Matthias Gottmann, Sunnyvale, CA (US)

Correspondence Address: FOLEY AND LARDNER LLP;SUITE 500, 3000 K STREET NW, WASHINGTON, DC, 20007, US

(73) Assignee: Ion America Corporation

(21) Appl. No.: 11/221,983

(22) Filed: Sep. 9, 2005

Related U.S. Application Data
(63) Continuation-in-part of application No. 10/853,194, filed on May 26, 2004, now abandoned.
Application No. 10/853,194 is a division of application No. 10/428,804, filed on May 5, 2003, now Pat. No. 6,908,702.
(60) Provisional application No. 60/608,902, filed on Sep. 13, 2004.
(60) Provisional application No. 60/377,199, filed on May 3, 2002.

(51) Int. Cl. H01M 8/04; H01M 8/06; H01M 8/12

(52) U.S. Cl. 429/19; 429/34; 429/32

(57) ABSTRACT

A hydrocarbon fuel storage device contains nanotubes adapted to store a hydrocarbon fuel. A hydrocarbon fuel storage method includes storing the hydrocarbon fuel in nanotubes. The nanotubes preferably are SWNTs having a total surface area of between 1,000 m²/g and 1587 m²/g.

### BACKGROUND OF THE INVENTION

The present invention is generally directed to fuel cell fuel storage materials and more specifically to carbon nanotube storage material for hydrocarbon fuel.

Fuel cells are electrochemical devices which can convert energy stored in fuels to electrical energy with high efficiencies. One type of high temperature fuel cell is a solid oxide fuel cell which contains a ceramic (i.e., a solid oxide) electrolyte, such as a yttria stabilized zirconia (YSZ) electrolyte. An anode electrode is formed on one side of the electrolyte and a cathode electrode is formed on the opposite side of the electrolyte. In a non-reversible fuel cell, the anode electrode is exposed to the fuel flow, such as hydrogen or hydrocarbon fuel flow, while the cathode electrode is exposed to oxidizer flow, such as air flow. In operation, oxygen ions diffuse through the electrolyte from the cathode side to the anode side and recombine with hydrogen and/or carbon on the anode side of the fuel cell to form water and/or carbon dioxide.

Fuel is often stored in compressed liquid or gas form. However, fuel stored in this fashion has a lower than desired density. Furthermore, fuel stored in this fashion may be too dangerous to be located on moving vehicles which may be involved in a collision or other type of accident.

It has been proposed to store hydrogen fuel in a carbon nanotube storage material. This storage method is considered to be safer than the compressed hydrogen storage method. However, the reported room temperature hydrogen storage capacities of carbon nanotubes have varied between zero and 60 weight percent, with a large majority of authors reporting a reproducible capacity below the 6.5 wt % target set by the U.S. Department of Energy. Thus, a fuel storage material with a higher capacity is desirable.

### BRIEF SUMMARY OF THE INVENTION

One preferred aspect of the present invention provides a hydrocarbon fuel storage device which contains nanotubes adapted to store a hydrocarbon fuel. A hydrocarbon fuel storage method includes storing the hydrocarbon fuel in nanotubes.

### BRIEF DESCRIPTION OF THE DRAWINGS

FIGS. 1 and 2 are system schematics of fuel cell systems according to preferred embodiments of the present invention.

### DETAILED DESCRIPTION OF THE PREFERRED EMBODIMENTS

The present inventors have realized that nanotubes may be used as hydrocarbon fuel storage materials. The nanotubes may be used to store the hydrocarbon fuel for fuel cell and other uses. The term “nanotubes” includes single wall carbon nanotubes (SWNTs), multiwall carbon nanotubes (MWNTs) and other carbon nanotube nanostructures, such as carbon nanohorns. Carbon nanohorns are a type of carbon nanotubes which have the same graphitic carbon atom structure as regular shaped carbon nanotubes, except that the nanohorns have an irregular, horn-like shape. When many of the nanohorns group together, an aggregate (a secondary particle) of about 100 nanometers may be created. Thus, any type of regular or irregular carbon nanotubes may be used to store hydrocarbon fuels.

Preferably, but not necessarily, high surface area nanotubes are used for hydrocarbon fuel storage. For example, carbon nanotubes having a total surface area greater than 1,000 m²/g were recently described in an article by Martin Cinke, et al., Chemical Physics Letters, 365 (2002) 69-74, incorporated by reference in its entirety. The article describes single walled carbon nanotubes having a total surface area of between 1,000 m²/g and 1587 m²/g. The present inventors realized that these SWNTs have a capability of adsorbing a large amount of hydrocarbons due to their high surface area to provide a high solid to gas ratio. The density of the stored hydrocarbons may be higher than that of hydrocarbons stored in compressed form in a pressure vessel.

The high surface area SWNTs are made by the HiPCo process followed by a two step purification procedure that reduces the iron content to less than one weight percent, such as about 0.4 wt %. The first purification step debundles nanotube ropes by a dimethylformamide (DMF)/ethylene diamine (EDA) treatment. The second purification step involves an HCl treatment and wet oxidation to remove metal and amorphous carbon, thus opening the pores in the nanotube material.

In the first purification step, a solvent mixture of 200 ml DMF (Aldrich, 99.9%) and 100 μl EDA (Aldrich, 99+%) is used to suspend 100 mg raw HiPCo SWNTs and this solution is stirred for 18 h followed by a 6.5 h sonication. The solution is then centrifuged and the solvent mixture is decanted. The precipitates are centrifuged and decanted twice with methanol as the washing solvent. The entire procedure is repeated once more. The amine and amide groups in these solvents can interact with the π-electrons on the surface of the carbon nanotubes. Therefore, this procedure helps to loosen the nanotube bundles.

In the second step, the DMF/EDA-treated SWNTs are suspended in 250 ml of 37% HCl (Aldrich) and sonicated for 15 min to get the nanotubes dissolved. The stirred solution is heated to 45° C. for 2 h. The solution is then diluted with double distilled water and cooled to room temperature because the centrifuged tubes cannot tolerate a high concentration of acid. The solution is centrifuged and decanted four times with double distilled water. The SWNTs are dried in air and placed in a quartz boat located at the center of a quartz tube connected to a water bubbler. A stream of wet air is fed into the quartz tube with the tube maintained at 225° C. for 18 h and then the SWNTs are cooled to room temperature. The HCl treatment removes the metals and the wet air oxidation removes the amorphous carbon. This aspect of the purification procedure (i.e., the entire second step) is repeated three more times, but with the wet air oxidation part modified slightly each time (325° C. for 1.5 h the first time, 425° C. for 1 h the second time and skipping the step entirely the third time).

The SWNT diameter ranges from about 0.93 to about 1.35 nm. In this nanotube material, the pore diameter ranges from about 1 to about 100 nm, with an average pore size of about 3.9 nm. The nanotube material has a pore volume of at least 0.8 cm³/g, such as about 0.8 to about 1.1 cm³/g (about 1.55 ml/g) for pores with a diameter between about 2 and about 10 nm. The external and internal surface areas for the nanotubes are up to 678 and 909 m²/g, respectively. The total surface area is 1587 m²/g. The high surface area allows the nanotube material to store large hydrocarbon fuel molecules in addition to smaller hydrogen molecules.

It should be noted that the nanotube material for hydrocarbon storage should not be considered limited to the SWNTs made by the two step method described above. Other SWNT and MWNT (i.e., multi-wall carbon nanotube) and nanohorn materials may also be used, preferably materials with a high surface area, such as an area of 1000 m²/g or higher. Other nanotube purification methods may be used, such as cutting the nanotubes by sonification in nitric acid by using an ultrasonic probe, for example. Furthermore, if desired, the nanotubes may be doped with suitable dopants, such as transition metal elements and alloys, which enhance adsorption of hydrocarbons to the nanotubes.

The hydrocarbon fuel is stored in the nanotubes by adsorption. However, it is possible that at least a portion of the hydrocarbon fuel is absorbed to the nanotubes. Preferably, the hydrocarbon fuel is used as a fuel for fuel cells. However, the hydrocarbons stored in the nanotube material do not necessarily have to be used as fuel and may be used for other applications.

Any suitable hydrocarbon fuel may be used. Preferably, the hydrocarbon fuel comprises methane or natural gas (which comprises methane and other gasses). Other hydrocarbon gases, such as pentane, butane, propane, methanol and other oxygenated hydrocarbon gasses as well as other biogases usable as fuel cell fuels may also be used.

The hydrocarbon storage device preferably comprises a storage container containing the nanotube material. The storage container may be any vessel or container which is suitable for holding nanotubes and which can be connected to a gas conduit or pipe. For example, the container may be a metal, plastic or ceramic tube or box in which the nanotubes are located. The container is connected to one or more gas conduit or pipes which provide the hydrocarbon fuel to and from the container. Preferably, a gas tight seal is provided between the container and the conduit(s) or pipe(s). Furthermore, one or more gas valves may be used to open and close access from the container to the conduit(s) or pipe(s).

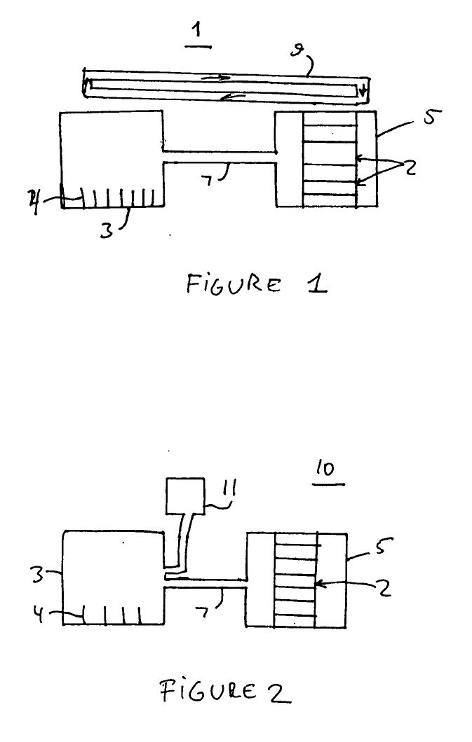

The hydrocarbon fuel storage device 3 is preferably located in a fuel cell system 1, as shown in FIG. 1. The system 1 includes a fuel cell stack 5 containing fuel cells 2 adapted to use the hydrocarbon fuel and the hydrocarbon fuel storage device 3 containing the nanotubes 4. The storage device is operatively connected to the fuel cell stack 5. Operatively connected means that the device 3 is either directly or indirectly connected to the stack 5, such that a fuel is supplied to the stack 5. For example, the device 3 may be connected by a conduit or pipe 7 directly to the stack 5. Alternatively, the device 3 may be indirectly connected to the stack 5. For example, the device may be connected to fuel processing equipment, such as a fuel reformer, which then provides a reformed fuel into the stack.

The fuel cell stack 5 may contain any suitable primary or regenerative fuel cells. Preferably, the fuel cells comprise solid oxide fuel cells. However, other fuel cell types, such as PEM, molten carbonate, direct methanol, etc., may also be used. The stack also contains a shell or housing, interconnects/gas separators located between the fuel cells, seals, electrical contacts and other equipment.

Solid oxide fuel cells contain a solid oxide (i.e., ceramic) electrolyte and anode and cathode electrodes. For example, the anode materials may comprise nickel (including essentially pure nickel and nickel alloys where nickel comprises greater than 50 weight percent of the alloy), copper (including essentially pure copper and copper alloys), metal cermets, such as Ni—YSZ and Cu—YS cermets, noble metals (including essentially pure noble metals and alloys), such as Ag, Pd, Pt and Ag—Pd or Ag—Pt alloys, chromium alloys, such as a proprietary high chromium anode alloy manufactured by Plansee AG of Austria, and conductive ceramics, such as strontium doped lanthanum chromite (LSC). For example, cathode materials may comprise conductive ceramics, such as strontium doped lanthanum manganite (LSM), strontium doped lanthanum chromite (LSC) and strontium doped lanthanum cobaltite (LSCo) and noble metals (including essentially pure noble metals and their alloys), such as an Ag—Pd alloy. The electrolyte material may comprise any suitable ceramic material, such as YSZ or a combination of YSZ with another ceramic such as doped ceria.

The hydrocarbon fuel storage device may be a temperature and/or a pressure swing adsorption device. In other words, the hydrocarbon fuel is adsorbed and desorbed from the nanotube material by changing a temperature and/or pressure inside the storage device where the nanotubes are located.

FIG. 1 illustrates a fuel cell system 1 containing a temperature swing adsorption storage device 3. The system contains a heating device 9 adapted to heat the storage device 3 to desorb the hydrocarbon fuel from the nanotubes in the storage device. When the hydrocarbon fuel is provided into the storage device 3 and the heating device 9 does not provide heat to the storage device 3, the hydrocarbon fuel is adsorbed to the nanotubes in the storage device 3. If desired, an optional cooling device may also be used to cool the storage device 3 below room temperature to improve hydrocarbon adsorption.

Preferably the heating device 9 comprises a heat transfer device adapted to transfer heat from the fuel cell stack 5 to the storage device 3. For example, the heating device 9 may be a pipe or conduit containing a heat transfer medium which contacts or passes close to both the fuel cell stack 5 and the storage device 3. The heat from the operating stack 5 is transferred by the pipe or conduit 9 to the storage device 3. The heat transfer medium may be air, water or water vapor, or other organic or inorganic fluids. The pipe or conduit 9 may be valved to control the timing and the amount of heat provided to the storage device 3. Alternatively, the heating device 9 may be a heater, such as a resistive or radiative heater, provided inside or outside of the storage device 3.

In another embodiment of the invention, the system 1 contains a pressure swing adsorption storage device 3. FIG. 2 illustrates a fuel cell system 10 that contains a pressurization device 11. The device 11 is adapted to lower a pressure in the storage device 3 to desorb the hydrocarbon fuel from the nanotubes in the storage device and to raise the pressure in the storage device 3 to adsorb the hydrocarbon fuel to the nanotubes. The pressurization device 11 may comprise a single or multi-stage compressor, for example. For example, due to the high surface area of the nanotubes, a single stage compressor 11 may be used and a pressure swing of only about 1 to 2 atmospheres may be used to store and release the hydrocarbons from the nanotubes. Thus, the storage container containing the nanotubes does not have to be pressure vessel (i.e., a high pressure or pressurized storage vessel) and may be a low pressure storage container.

The fuel cell systems 1, 10 may be used to generate electric power (i.e., electricity) for any suitable application. For example, the fuel cell systems may be used to generate power for buildings, vehicles (such as airborne, ground based and water based vehicles), stationary and portable electronic devices. For example, in a vehicle, such as a ground based vehicle (such as a truck, a car, a motorcycle or a moped), the hydrocarbon fuel storage device 3 may be incorporated into the vehicle body to save space in the interior of the vehicle. For example, the hydrocarbon fuel storage device may be located in at least one of a door, a hood, a frame and a chassis of the vehicle.

A method of operating the hydrocarbon fuel storage device 3 includes storing the hydrocarbon fuel in nanotubes. The hydrocarbon fuel may be stored by at least one of adsorption and absorption. Preferably, it is stored by pressure and/or temperature swing adsorption. In temperature swing adsorption, a hydrocarbon fuel is provided to the nanotubes while the temperature of the nanotubes is lowered, preferably to a room temperature or below. In pressure swing adsorption, a hydrocarbon fuel is provided to the nanotubes while raising the pressure in the container housing the nanotubes.

When desired, the stored fuel is released from the nanotubes, for example, by pressure and/or temperature swing desorption, and provided to a fuel cell or other suitable device. The fuel cell then uses the fuel to generate electric power. For example, in temperature swing desorption, the nanotubes are heated to desorb the hydrocarbon fuel from the nanotubes. The nanotubes may be heated by a heater or by transferring heat from the fuel cell stack to the nanotubes. In pressure swing desorption, a pressure of the nanotubes is lowered to desorb the hydrocarbon fuel from the nanotubes.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

1. A fuel cell system, comprising:
a fuel cell stack containing fuel cells;
a hydrocarbon fuel storage device operatively connected to the fuel cell stack; and
a heating device adapted to heat the storage device to desorb the hydrocarbon fuel from the nanotubes in the storage device;
wherein the hydrocarbon fuel storage device comprises nanotubes adapted to store a hydrocarbon fuel and the heating device comprises a heat transfer device adapted to transfer heat from the fuel cell stack to the storage device.

2. The system of claim 4, wherein the nanotubes comprise carbon nanotubes having a total surface area greater than 1,000 m²/g.

3. The system of claim 2, wherein:
the carbon nanotubes comprise single walled carbon nanotubes having a total surface area of between 1,000 m²/g and 1587 m²/g;
the hydrocarbon fuel is selected from methane and natural gas; and
the fuel cells comprise solid oxide fuel cells.

4. The system of claim 1, wherein the nanotubes contain a hydrocarbon fuel absorbed or adsorbed to the nanotubes.

5-6. (canceled)

7. The system of claim 4, further comprising a pressurization device adapted to lower a pressure in the storage device to desorb the hydrocarbon fuel from the nanotubes in the storage device and to raise the pressure in the storage device to adsorb the hydrocarbon fuel to the nanotubes.

8. A vehicle comprising:
a vehicle body; and
a fuel cell system of claim 4.

9. The vehicle of claim 8, wherein:
the vehicle comprises a truck, a car, a motorcycle or a moped; and
the hydrocarbon fuel storage device is located in at least one of a door, a hood, a frame and a chassis of the vehicle.

10-15. (canceled)

16. A method of operating a fuel cell system, comprising:
providing a stored hydrocarbon fuel from nanotubes to a fuel cell stack containing fuel cells;
heating the nanotubes to desorb the hydrocarbon fuel from the nanotubes prior to providing the hydrocarbon fuel from the nanotubes to the fuel cell stack, wherein the step of heating comprises transferring heat from the fuel cell stack to the nanotubes; and
operating the fuel cells to generate electric power.

17. The method of claim 16, wherein the nanotubes comprise carbon nanotubes having a total surface area greater than 1,000 m²/g.

18. The method of claim 17, wherein:
the carbon nanotubes comprise single walled carbon nanotubes having a total surface area of between 1,000 m²/g and 1587 m²/g;
the hydrocarbon fuel is selected from methane and natural gas; and
the fuel cells comprise solid oxide fuel cells.

19-20. (canceled)

21. The method of claim 16, further comprising lowering a temperature of the nanotubes and providing a hydrocarbon gas to the nanotubes to store the hydrocarbon fuel in the nanotubes.

22. The method of claim 16, further comprising:
lowering a pressure of the nanotubes to desorb the hydrocarbon fuel from the nanotubes prior to providing the hydrocarbon fuel from the nanotubes to the fuel cell stack; and
raising the pressure of the nanotubes and providing a hydrocarbon gas to the nanotubes to adsorb the hydrocarbon gas to the nanotubes.

23. The method of claim 16, wherein the nanotubes are located in a vehicle.

24. (canceled)
